(19) United States
(12) Patent Application Publication
(10) Pub. No.: US 2007/0244608 A1
(43) Pub. Date: Oct. 18, 2007

(54) Ground control station for UAV

(75) Inventors: Manaswini Rath, Bangalore (IN); Nandeesha D. Shekarappa, Bangalore (IN); Venkatesh Ramachandra, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/403,472

(22) Filed: Apr. 13, 2006

(51) Int. Cl. G06F 17/00

(52) U.S. Cl. 701/3; 701/23

(57) ABSTRACT

A ground control station to control an unmanned air vehicle during a manual mode of operation includes a processing unit, a telemetry/telecommand module, a user control module, a graphical user interface, and a wireless datalink subsystem. The wireless datalink subsystem is configured for remote communication with the unmanned air vehicle. The telemetry/telecommand module is coupled to the ground control station and is configured to download onboard data from the unmanned air vehicle to the ground station, and further is configured to upload commands from the ground station to the unmanned air vehicle. The graphical user interface includes a display module that is configured to display a plurality of downloaded UAV onboard data. The user control module is coupled to the ground control station to implement user control of a plurality of control surfaces of the unmanned air vehicle during manual mode operation of said UAV via said processing unit.

### TECHNICAL FIELD

Various embodiments relate to unmanned air vehicles, and in an embodiment, but not by way of limitation, to ground control systems to control such unmanned air vehicles.

### BACKGROUND

Unmanned Air Vehicles (UAV) come in a variety of shapes and sizes, and have many applications in military, commercial, and research endeavors. One concern that is common to all UAVs, because by definition there is not an on board pilot, is the proper control and commanding of such UAVs. Specifically, the operation of UAVs in an autonomous mode as is know in the art is not foolproof, and problems can and do arise in such autonomous systems.

### SUMMARY

A ground control station to control an unmanned air vehicle (UAV) during a manual mode of operation includes a management unit, a telemetry module, a user control module, a graphical user interface, and a wireless datalink subsystem. The wireless datalink subsystem is configured for remote communication with the unmanned air vehicle. The telemetry module is coupled to the ground control station and is configured to download onboard data from the unmanned air vehicle to the ground station, and further is configured to upload commands from the ground station to the unmanned air vehicle. The graphical user interface includes a display module that is configured to display a plurality of downloaded UAV onboard data. The user control module is coupled to the ground control station to implement user control of a plurality of control surfaces of the unmanned air vehicle during manual mode operation of said UAV via said input device.

### BRIEF DESCRIPTION OF THE DRAWINGS

FIG. 1 illustrates an example embodiment of a system to control an unmanned air vehicle and other air vehicles.

FIG. 2 illustrates an example embodiment of modules incorporated into a human machine interface in a ground control station system.

FIG. 3 illustrates an example embodiment of a packet definition of the communication system of FIG. 1.

FIG. 4 illustrates an example embodiment of an interaction diagram of the central control system that may be used in connection with the system of FIG. 1.

FIG. 5 illustrates an example embodiment of an interface that illustrates the command line control system that may be used in connection with the system of FIG. 1.

FIG. 6 illustrates another example embodiment of an interface that illustrates the command center that may be used in connection with the system of FIG. 1.

FIG. 7 illustrates another example embodiment of an interface that illustrates the REAT (Rudder, Elevator, Aileron, Throttle) controller that may be used in connection with the system of FIG. 1.

FIG. 8 illustrates an example embodiment of a block diagram of a receiver unit that may be used in connection with the system of FIG. 1.

FIG. 9 illustrates an example embodiment of a block diagram of a transmitter unit that may be used in connection with the system of FIG. 1.

FIG. 10 illustrates an example embodiment of a computer system upon which embodiments of the system of FIG. 1 may operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for an architecture for a ground control system for an unmanned air vehicle, in accordance with embodiments of the invention. A number of figures show flow diagrams illustrating operations for a ground control system architecture for an unmanned air vehicle system. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In an embodiment, a ground control station addresses some of the shortcomings of an autonomous flight mode of an unmanned air vehicle (UAV) system by providing for remote piloting of the UAV. Such a ground control station for remote piloting may not only prevent disasters involving the UAV, but it may also allow the maintenance of UAV flight information. Such information may include attitude data, health status, payload information, and flight information. This information assists in the analysis of UAV operations and in further UAV flight improvements. Additionally, the ground station remote control of the UAV allows a remote pilot to enable optimal use of individual subsystems on the UAV, thereby assuring efficient performance and endurance.

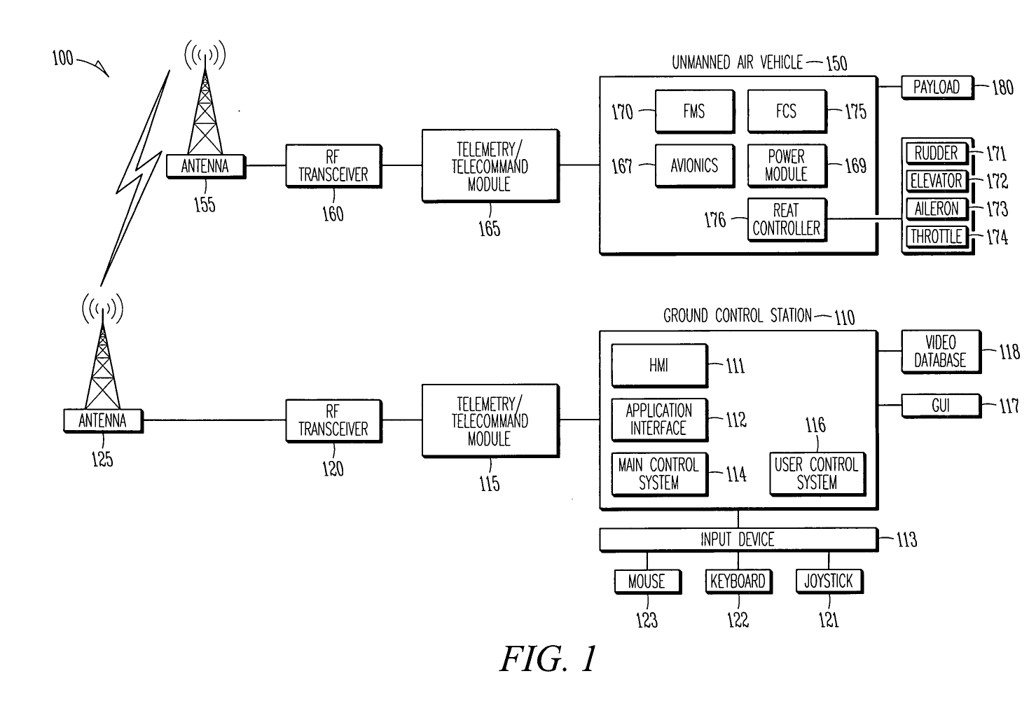

FIG. 1 illustrates a block diagram of an embodiment of a system 100 in which a ground control station (GCS) 110 communicates with an unmanned air vehicle (UAV) 150. The ground control station is coupled to a telemetry/telecommand module (TTC) 115. The term telecommand is used in connection with the GCS 110 transmitting commands to the UAV 150, and the term telemetry is used in connection with the UAV 150 transmitting data to the GCS 110. The TTC module 115 is connected to a radio frequency (RF) transceiver 120, which in turn is coupled to an antenna 125. The GCS 110, the TTC module 115, the RF transceiver 120, and the antenna 125 may all be considered part of the GCS side of the system 100. The GCS side of the system 100 is coupled to the UAV side of the system via RF signals. On the UAV side of the system, there is an antenna 155 on the UAV 150 that receives the RF signals from the GCS side of the system and transmits signals to the GCS 110. The antenna 155 is coupled to a RF transceiver 160, which in turn is coupled to a TTC module 165. The UAV 150 includes a flight management system 170 (FMS) and a flight control system 175 (FCS).

The GCS 110 provides the ability to remotely pilot or self-pilot the UAV 150, and further provides updates to the ground pilot with real time data concerning the UAV 150. The UAV 150 may carry payloads 180 such as cameras, sensors, and communications equipment. The UAV 150 further may include an on board avionics system 167 and a power system 169. In general, the GCS 110 is responsible for uploading the necessary information to the on board system 167, receiving downloaded information from the UAV 150, and controlling and monitoring the progress of the UAV 150 throughout the mission profile.

The GCS 110 includes a hardware system and a software system. The GCS software system includes a human machine interface module 111 (HMI), a communication interface (TTC module 115), and an application interface 112. The GCS software system provides a variety of functions. It displays the status of the UAV 150 on a display unit that is part of the HMI 111 (based on data received from the telemetry system), and generates a waypoint file from the FMS interface 170. The waypoint file contains the positional information of the waypoints that the UAV needs during autonomous flight. In an embodiment, the GCA 110 provides the waypoint file to the FMS module through the telecommand system. The GCS software further permits complete control of the UAV 150 in the manual mode of flight through and input device 113 such as a joystick 121, a keyboard 122, or a mouse 123. The GCS software further provides control support during shared operation mode of the UAV through the UAV control devices. The GCS software further establishes the connection with the on board flight system, and verifies the functionalities of the flight controls.

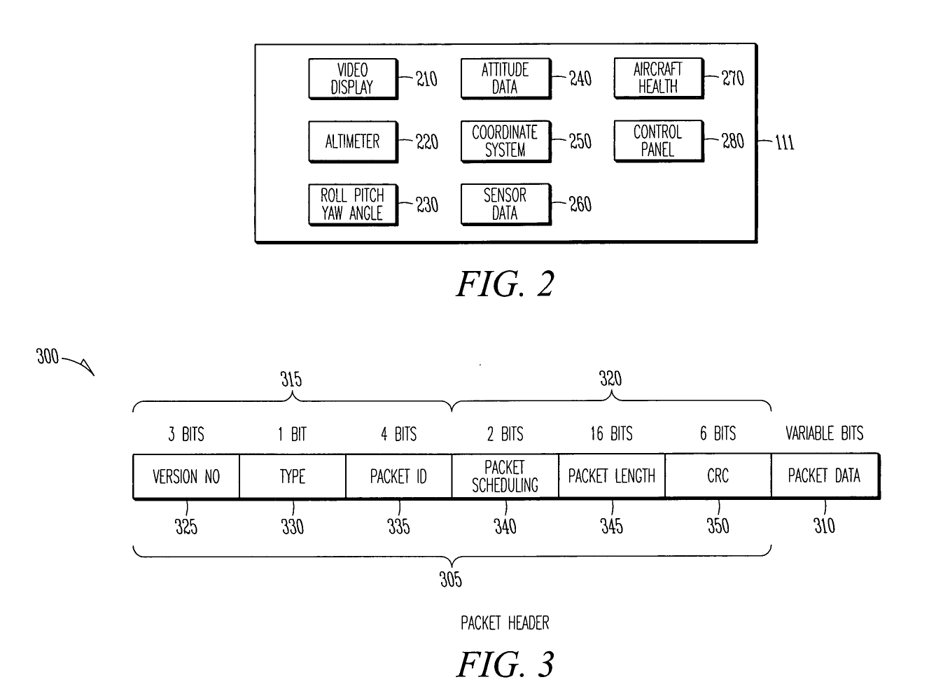

The human machine interface 111 of the GCS 110 is similar to an on board cockpit display, and is illustrated in a block form in FIG. 2. The UAV 150 transmits to the GCS 110 all the information necessary to remotely pilot the UAV. As illustrated in FIG. 2, the HMI 111 includes a display that includes a video display 210 from an on board video sensor, and altimeter 220, graphical and numerical representations 230 of roll, pitch, and yaw angle; navigational view of attitude data 240, current position of the UAV with world coordinate system 250, real time graph for raw sensor data 260, display of data regarding the health of the aircraft 270, and a control panel 280 for remotely piloting the aircraft. The HMI 111 interacts with the GCS main control system 114 and the user control system 116. The main control system 114 is responsible for handling both telemetry and telecommands in real time by retrieving telemetry information and uploading telecommand-information. In an embodiment, the communications system may be view as a Telemetry-Telecommand (TTC) subsystem 115, 165 and the Radio Frequency (RF) subsystem 120, 160. The user control system 116 is responsible for generating control commands required for the remote piloting of the UAV 150. The user control system 116 receives input from the input device 113, and whenever such input is received, the user control system 116 determines the actions of the user and calls appropriate functions to handle the events generated.

Through the user input device 113, a pilot may control the rudder 171, elevator 172, aileron 173, and throttle 174 (collectively referred to as REAT) of the UAV 150. Input via the input device is transmitted to a REAT controller 176, which in turn controls the REAT components.

Telemetry involves collection and packetization of on board sensor data, UAV health data, and processed sensor data. The on board system 167 transmits this data to the GCS 110 in frames. The GCS 110 receives this data, checks for errors, parses the fields in the data, and directs each piece of data to the appropriate display of the graphical user interface.

The RF subsystem (RF transceivers 120 and 160, and antennas 125 and 155) is the intermediate system between the telemetry and telecommand systems 115 and 165. The RF subsystem establishes an RF link between the antenna 155 on board the UAV 150 and the GCS 110 via antennas 125 and 155 to facilitate the exchange of telemetry data and telecommands. The RF subsystem also has a role in tracking and monitoring the UAV 150, and taking corrective action if required. The GCS software receives data from the UAV 150 via the ground based RF transceiver 120, it parses the received bit stream for all necessary data, and transmits the data to the appropriate screens on a GUI 117 of the GCS 110.

In an embodiment, the structure of a telecommand and telemetry packet 300 format is illustrated in FIG. 3. The packet 300 includes a packet header 305 and a packet data field 310. The packet header 305 is further divided into a packet identification 315 and a packet control 320. The packet identification 315 includes a 3 bit version number 325, a 1 bit type 330, and a 4 bit packet ID 335. The version number 325 is the version of the telemetry packet. The type 330 indicates whether the packet 300 is a telecommand or a telemetry packet. The packet ID 335 indicates the type of the packet such as sensor packet, FMS packet, FCS packet, and health packet. The packet control portion 320 of the packet header 305 includes 2 bit packet sequencing 340, a 16 bit packet length 345, and a 6 bit CRC 350. The packet sequencing 340 defines different types of sequencing of packets in a frame. The packet length 345 indicates the length of a packet, and the CRC 350 is for error correction and coding.

In an embodiment, a packet 300 is categorized. In particular, telemetry packets are categorized in order to extract the on board information in an organized manner as well as quickly and easily. The GCS 110 analyzes the packets sent to it from the UAV 150 on board system and categorizes these packets as sensor packets, FMS/FCS packets, health packets, and payload packets. The packets are placed into these categories depending upon the information contained in these packets.

The UAV 150 may carry a camera as its payload 180 for such purposes as reconnaissance and surveillance missions. The GCS 110 facilitates camera operations through the applications interface 112. The interface 112 on the GCS 110 for the camera includes a TV tuner card. In the GCS 110, there is software for displaying the video information from the camera and archiving the video data. The on board system receives video data from the camera and inputs this information to the on board camera control software. The on board camera control software is responsible for processing video information and providing this processed video information as an input to the on board RF transceiver 160. The transmitted video information is received at the ground station 110 where it serves as input to the ground video display software. The GCS video display software displays the video on the GCS GUI 117 and archives the video in a database 118 for future analysis.

The video interface includes three subsystems—an on board video system, the video communication system, and the ground video system. The on board video system interacts with the UAV video camera and transfers the video data collected by the camera to the video communication system. The on board video system interacts with the camera for collecting the video data and also for controlling camera parameters such as zooming in or out. The video communication system transfers the video data from the on board video system to the ground receiver 125 of the video communication system. The ground video receiver (RF transceiver 120) functions as a conduit for the transfer of this video data to the ground video control system 110. The ground video system reads the data from the video receiver, displays the video data for viewing by the ground pilot, and facilitates image processing of the video data.

As previously disclosed, the video display software displays the video data sent from the UAV 150. The video data is received by a ground video receiver, and a ground control video display interacts with a TV tuner card and a video driver to obtain and display the video information on the GUI 117. A ground-based pilot may use this video data to monitor and control the activities of the UAV 150.

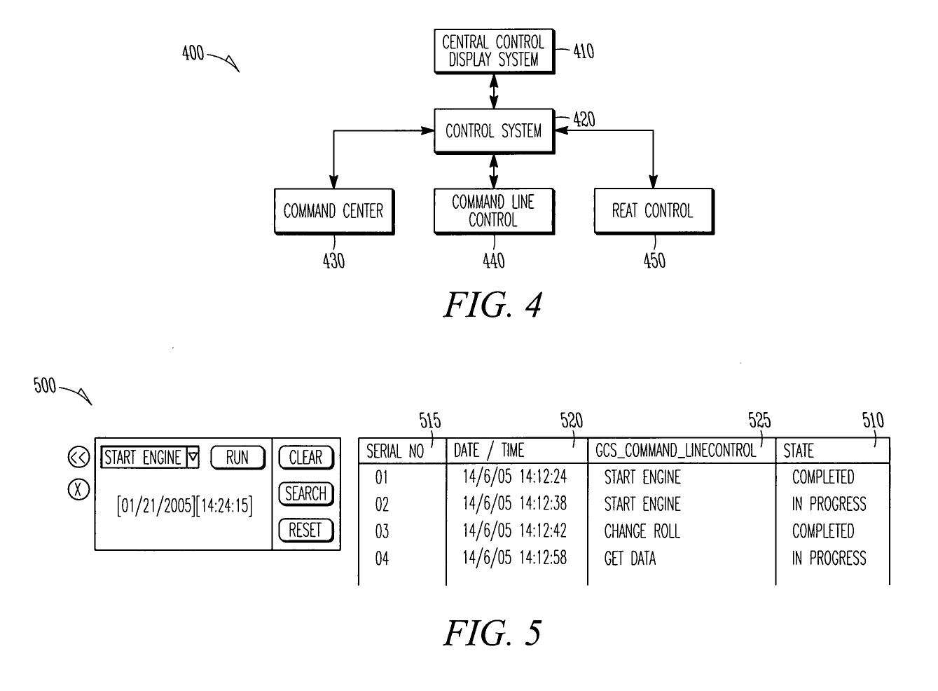

The UAV controls are responsible for controlling the behavior of the UAV 150 during flight. The control commands are transmitted to the on board system 167 by means of the telecommands. The actions implemented for these control commands are reflected in the corresponding control panels of the GUI 117, after the on board system 167 sends an acknowledgment for these commands. FIG. 4 illustrates in particular an embodiment of the UAV control interaction 400. FIG. 4 illustrates the central control display system 410 in communication with the control system 420. The control system 420 in turn is in communication with the command center 430, the command line control 440, and the REAT control 450.

An embodiment of the command line control system is illustrated in FIG. 5. It is a keyboard control system for controlling the UAV 150. The command line control system 500 provides to the pilot a set of control commands. Such a predefined set of commands may be presented to the pilot via a drop down menu. Upon the selection of a command, the command is sent as a telecommand, and the command status is reported in the command state 510 as illustrated in FIG. 5. The status list contains information about the serial number 515 of the command, the date and time 520 that the command was issued, the command identifier 525, and the command status or state 510. The status of the command remains in progress until an acknowledgement is received from the on board system 167 of the UAV 150. In an embodiment, a pilot may search through the commands that have already been sent to the UAV. This helps a pilot avoid the unnecessary sending of commands that have already been sent. The search functionality has a normal mode and a safe mode. In the normal mode, the user can send multiple commands to the central control system, and the on board system 167 is responsible for handling these multiple commands. In the safe mode, confirmation by the pilot is required before a command is accepted by the UAV. A pilot may also sort the command history by serial number 515, date and time 520, or other identifying features of the commands.

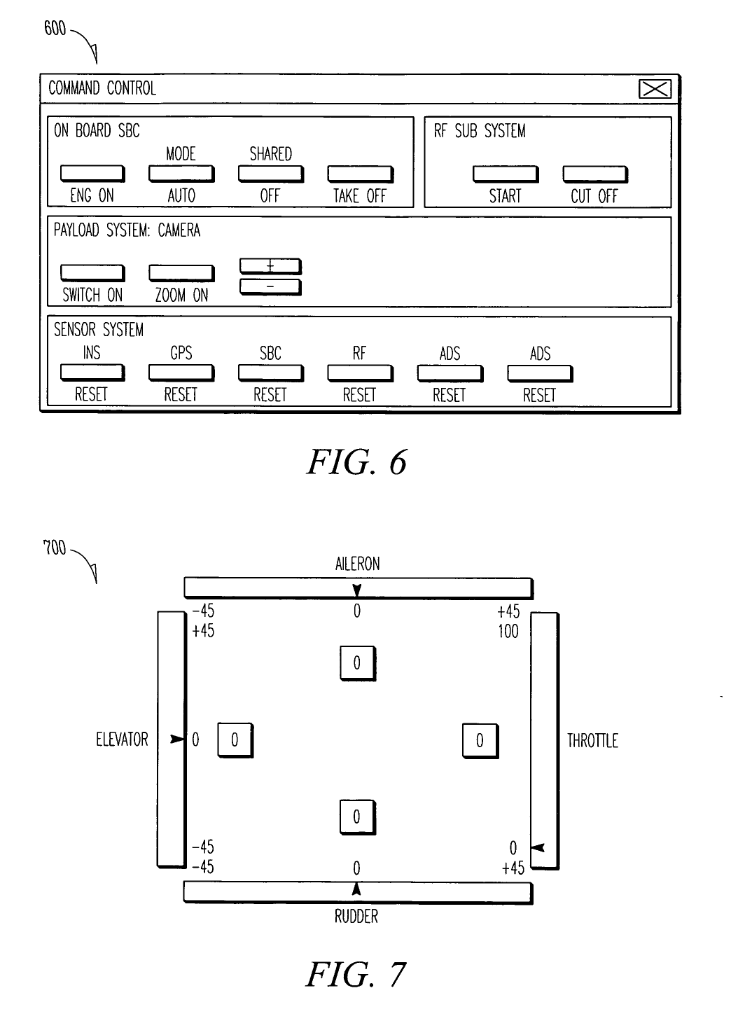

The command center system 600 as illustrated in FIG. 6 is an alternative for the command line control system. All the commands in the form of a list or drop down menu of the command line control system 500 are represented as control buttons in the command control center system 600. The command control center system 600 also operates in normal mode and safe mode like the command line control system.

The REAT controller 176 is used for controlling the control surfaces of the UAV 150, thereby permitting a pilot to control the movement, trajectory, and path of the UAV. A pilot interacts with the REAT controller 176 through a keyboard, joystick, mouse, or other input device 113. An example of a REAT controller screen interface 700 is illustrated in FIG. 7. The inputs provided by the pilot to the input device are translated into angular values by the GCS 110, and these angular values are sent to the on board system 167 through the RF system (120, 160) as telecommand signals.

The GCS 110 will permit complete control of the UAV in the manual mode through the input device 113 such as a joystick or a keyboard. The GCS 110 includes the RF transceiver 120 the GUI 117. The RF system (120, 160) establishes an RF link between the on board antenna 155 of the UAV and the GCS 110 to facilitate the exchange of telemetry data and telecommands. The RF system also allows the tracking and monitoring of the UAV 150 and the taking of corrective steps if required. The RF system also receives data from the RF transceivers 120, 160, obtains a clear bit stream from the data through bit synchronization and frame synchronization, and decommutates the bit stream for all necessary data that should be sent to the graphical user interface. The GUI 117 displays the status of the UAV 150 based on the data received from the telemetry, and generates a waypoint file from the FMS interface 170.

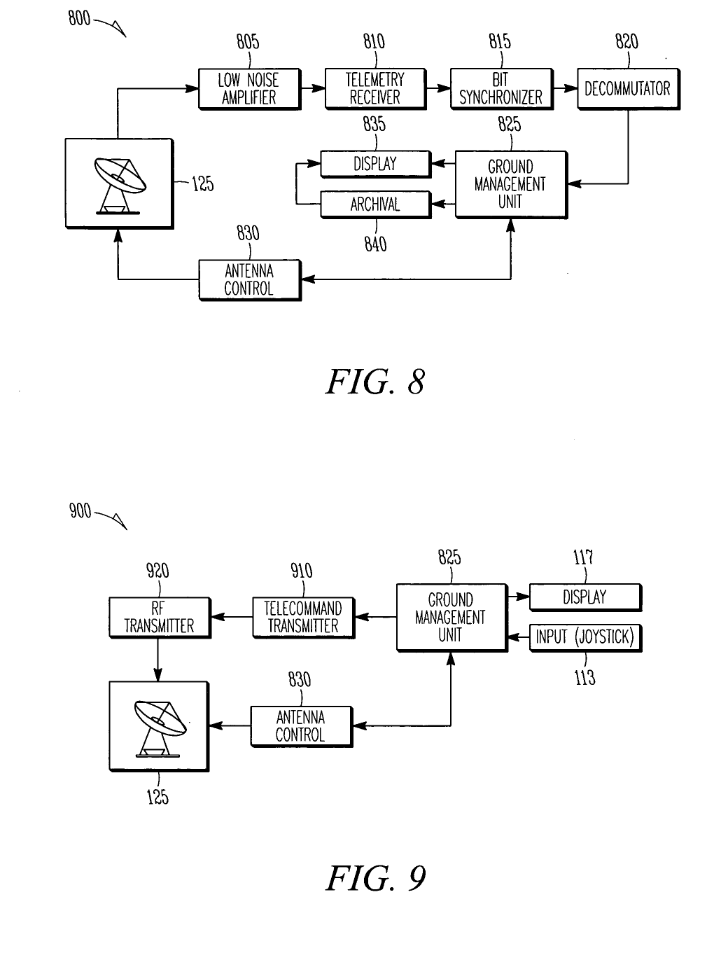

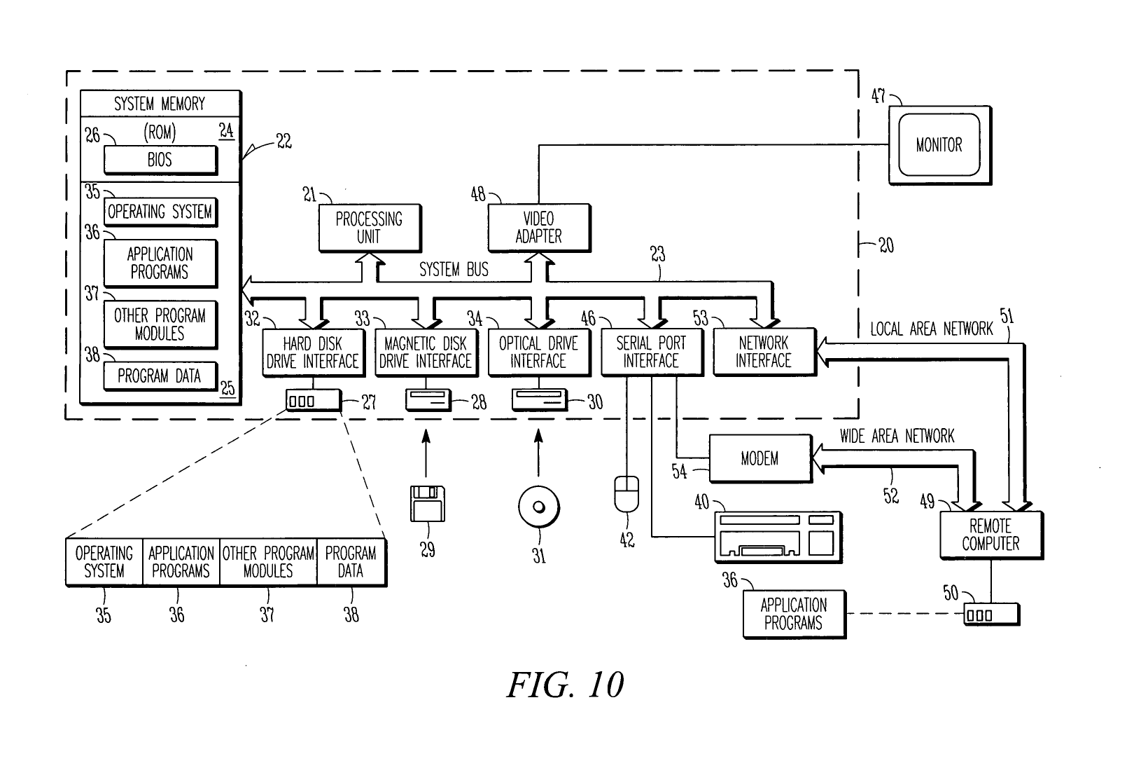

The GCS 110 includes two modules—the receive unit and the transmit unit. An embodiment of the receive unit is illustrated in FIG. 8, and an embodiment of the transmit unit is illustrated in FIG. 9. The receive unit 800 illustrated in FIG. 8 includes the antenna 125 coupled to a low noise amplifier 805. The low noise amplifier is connected to a telemetry receiver 810, which in turn is coupled to a bit synchronizer 815. The output of the bit synchronizer is fed to a decommutator 820 which is used to synchronize the bits in the system, and the output of the decommutator 820 is supplied to a ground management unit 825. The ground management unit manages the display 835 of data from the UAV 150 on GUI 117, the compression and archival 840 of any such data in the database 118, and antenna control through antenna control module 830. In general, the GCS receive unit 800 receives data form the on board unit 167 of the UAV 150 through the RF link. The GCS receive unit 800 is also responsible for monitoring and displaying the status of the UAV based on the data received from the UAV. Based on the data received from the UAV, the GCS receive unit 800 may also transmit a telecommand to the UAV, adjust the antenna 125 through the antenna control 830 based on the movement of the UAV, display statuses of the UAV such as position, roll, pitch, and yaw data, and store data from the UAV for future analysis.

An embodiment of the GCS transmit unit 900 is illustrated in FIG. 9. The transmit unit includes the antenna 125, the ground management unit 825, the display or GUI 117, and the antenna control module 830 as in the GCS receive unit 800. The GCS transmit unit further includes the input device 113 in communication with the ground management unit 825, a telecommand transmitter 910, and an RF transmitter 920. The GCS transmit unit 900 transmits data, and more particularly telecommands, from the ground to the UAV 150 through the RF link. Telecommands are sent to the UAV to control the flight of the UAV and to address problems on the UAV reported by the health monitoring systems.

The GCS 110 includes the telemetry and telecommand subsystems, the RF subsystem, the ground management unit, the antenna control module, the display, and the manual control unit (input). The telemetry subsystem establishes air to ground communications, and the telecommand system establishes ground to air communications. The RF subsystem establishes a wireless RF link between the UAV 150 and the GCS 110, and is an intermediate system between the telemetry and telecommand subsystems. The ground management unit receives on board raw sensor data from the telemetry subsystem, and it processes the data to be displayed and sends that data to the display unit. It also issues commands to the antenna control unit, and computes the control commands based on user input in the manual or shared mode, or based on the data received from the UAV in the manual or autonomous modes. In an embodiment, the antenna control module receives input from the ground management unit, and drives servomotors to orient the RF antenna. The display may include graphical and numerical representations of the roll, pitch, and yaw, attitude data, current position of the UAV, FMS related displays, raw sensor data, health data, and fuel status. The manual control unit is used by a pilot to control the UAV and includes such functionalities/commands as engine start and stop, take off, health status, throttle control, rudder control, aileron, elevation control, file transfer commands, and payload control commands.

In the manual mode, the UAV 150 is controlled manually through the RF subsystem. The RF subsystem works independently of the on board system. The RF subsystem directly controls the actuators. In the autonomous mode, UAV control is performed by the on board FMS 170. The FMS 170 provides the desired controls to the FCS 175 to control the actuators. The RF subsystem becomes a part of the TTC 115, 165 system in this mode. In the shared mode, the GCS 110 is given the option to control the UAV 150 either through the autonomous mode or the manual mode. Unlike the manual mode however, the manual control of the UAV 150 is performed by the telecommands, which are given to the FCS 175. The FCS decides whether the control of the actuators is done through the FMS 170 or through manual telecommands. In this mode, the RF subsystem is part of the TTC system.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A system comprising:
a ground control station to control an unmanned air vehicle during a manual mode of operation;
a processing unit coupled to said ground control station;
a wireless datalink subsystem configured for remote communication with said unmanned air vehicle;
a telemetry/telecommand module coupled to said ground control station and configured to download onboard data from said unmanned air vehicle to said ground station and to upload commands from said ground station to said unmanned air vehicle;
a graphical user interface coupled to said ground control station and comprising a display module configured for display of a plurality of downloaded onboard data from said unmanned air vehicle; and
a user control module coupled to said ground control station to implement user control of a plurality of unmanned air vehicle control surfaces during manual mode operation of said unmanned air vehicle via said processing unit.

2. The system of claim 1, wherein said on board data includes one or more of sensor data, payload data, and subsystem health data.

3. The system of claim 1, wherein said control surfaces include a rudder, an elevator, an aileron, and a throttle.

4. The system of claim 1, further comprising a payload, said payload including one or more of a camera, an infrared sensor, and a weather detection sensor, and said payload coupled to an on board system of said unmanned air vehicle.

5. The system of claim 1, further comprising a video database and display coupled to said ground control station, said video database to store video data received from said unmanned air vehicle in real time, and said display to display said stored video data.

6. The system of claim 1, wherein said unmanned air vehicle comprises on board avionics further comprising a flight management system and a flight control system.

7. The system of claim 1, wherein said graphical user interface displays one or more of sensor data; a video display; altitude data; roll, pitch, and yaw data; a coordinate system; on board subsystem health data; a command list; and a control panel for remote piloting.

8. The system of claim 1, wherein said telemetry/telecommand module comprises a data packet, and wherein said data packet comprises a packet id, a version number, a type, packet scheduling data, a packet length, a CRC, and a data field comprising all information to be downloaded or uploaded.

9. The system of claim 1, wherein said user control module comprises:
a command center;
a command line control; and
a REAT control.

10. The system of claim 9, where said command line control comprises a command serial number, a timestamp for a command, a command description, and a command state.

11. The system of claim 1, wherein said wireless data subsystem comprises:
a receive unit; and
a transmit unit.

12. The system of claim 11, wherein said receive unit comprises:
an antenna;
a low noise amplifier coupled to said antenna;
a telemetry receiver coupled to said low noise amplifier;
a bit synchronizer coupled to said telemetry receiver;
a decommutator coupled to said bit synchronizer; and
a ground management unit coupled to said decommutator;
wherein said ground management unit comprises a display, an archive, and an antenna control module.

13. The system of claim 11, wherein said transmit unit comprises:
a ground management unit;
a processing unit coupled to said ground management unit;
an antenna control module coupled to said ground management unit;
a telecommand transmitter to receive input from said ground management unit; and
an RF transmitter to receive input from said telecommand transmitter.

14. A system comprising:
a ground control station to control an unmanned air vehicle;
a processing unit coupled to said ground control station;
a wireless datalink subsystem configured for remote communication with said unmanned air vehicle;
a telemetry/telecommand module coupled to said ground control station;
a graphical user interface coupled to said ground control; and
a user control module coupled to said ground control station.

15. The system of claim 14, wherein said control module comprises a joystick and a keyboard that are integrated to said ground control station, and a REAT display integrated to a display unit of said ground control station.

16. The system of claim 14, wherein said telemetry/telecommand module is configured to download onboard data from said unmanned air vehicle to said ground station and to upload commands from said ground station to said unmanned air vehicle.

17. The system of claim 14, wherein said graphical user interface comprises a display module configured for display of a plurality of downloaded onboard data from said unmanned air vehicle.

18. The system of claim 14, wherein said user control module is configured to implement user control of a plurality of unmanned air vehicle control surfaces during manual mode operation of said unmanned air vehicle via said processing unit.

19. The system of claim 18, wherein said control surfaces include a rudder, an elevator, an aileron, and a throttle.

20. A system comprising:
a ground control station to control an unmanned air vehicle during a manual mode of operation;
a processing unit coupled to said ground control station;
a wireless datalink subsystem configured for remote communication with said unmanned air vehicle;
a telemetry/telecommand module coupled to said ground control station and configured to download onboard data from said unmanned air vehicle to said ground station and to upload commands from said ground station to said unmanned air vehicle;
a graphical user interface coupled to said ground control station and comprising a display module configured for display of a plurality of downloaded onboard data from said unmanned air vehicle; and
a user control module coupled to said ground control station to implement user control of one or more of a rudder, an elevator, an aileron, and a throttle positioned on said unmanned air vehicle during manual mode operation of said unmanned air vehicle via said processing unit.
